(19) United States
(12) Patent Application Publication
(10) Pub. No.: US 2025/0216071 A1
(43) Pub. Date: Jul. 3, 2025

(54) RAPID MIXING SYSTEMS AND METHODS FOR FUEL BURNERS

(71) Applicant: Mesodyne Inc., Somerville, MA (US)

(72) Inventors: Walker Chan, Cambridge, MA (US); Andrew Gilstrap, Malden, MA (US); John Battaglioli, Ballston Lake, NY (US)

(73) Assignee: Mesodyne Inc., Somerville, MA (US)

(21) Appl. No.: 18/849,966

(22) PCT Filed: May 8, 2023
(86) PCT No.: PCT/US2023/021343

§ 371 Date: Sep. 23, 2024

Related U.S. Application Data
(60) Provisional application No. 63/339,617, filed on May 9, 2022.

(51) Int. Cl. F23D 14/24; F23D 14/48; F23D 14/62; F23D 14/70; H02S 10/30

(52) U.S. Cl. CPC F23D 14/24; F23D 14/48; F23D 14/62; F23D 14/70; H02S 10/30; F23D 2200/00; F23D 2203/007

(57) ABSTRACT

The present disclosure generally relates to fuel burners, for example, for use with photonic crystals as part of thermophotovoltaic power generators or with other thermal power generators. In certain aspects, fuel is supplied into a reaction tube and mixed between swirling streams of gases moving in opposite directions (e.g., clockwise and counterclockwise) within the tube. This may allow for rapid mixing and relatively complete oxidation or combustion of the fuel. Heat may be extracted from the heated exhaust and may be supplied to a thermal power generator to produce power. For example, the heat may be supplied to an emitter comprising a photonic crystal, which can be used to direct electromagnetic radiation to a thermophotovoltaic cell to produce power. In addition, certain embodiments are directed to relatively small burners, e.g., that can burn fuel at less than 20 ml/min to produce power. Other aspects are generally directed to various combustion methods for such burners, methods of making or using such burners, kits involving such burners, or the like.

### RELATED APPLICATIONS

This application claims the benefit of U.S. Provisional Patent Application Ser. No. 63/339,617, filed May 9, 2022, entitled “Rapid Mixing Systems and Methods for Fuel Burners,” by Chan, et al., incorporated herein by reference in its entirety.

### FIELD

The present disclosure generally relates to fuel burners, for example, for use with photonic crystals as part of thermophotovoltaic power generators or with other thermal power generators.

### BACKGROUND

There has been interest in developing portable burners that can burn fuel to produce power in situations where power from an electric grid is unavailable. Thus, for example, fuel may be supplied to a burner and used to produce power, e.g., by burning or oxidizing the fuel. However, many heavy fuels, such as diesel, jet fuel, kerosene, etc. have certain characteristics that make them difficult to burn or oxidize reliably, including having a wide boiling range and a tendency to produce coke when heated. Accordingly, improvements in burner technologies are needed.

### SUMMARY

The present disclosure generally relates to fuel burners, for example, for use with photonic crystals as part of thermophotovoltaic power generators or with other thermal power generators. The subject matter of the present disclosure involves, in some cases, interrelated products, alternative solutions to a particular problem, and/or a plurality of different uses of one or more systems and/or articles.

Certain aspects are generally directed to an apparatus. For example, in one set of embodiments, the apparatus may comprise a tube, an inner swirler configured to direct a first gas to flow in a first tangential direction within the tube, an outer swirler configured to direct a second gas to flow in an opposed second tangential direction within the tube, a fuel distributor configured to distribute fuel between the first gas flow and the second gas flow, and a thermal power generator positioned to receive heat produced by a reaction of the fuel within the tube.

In another set of embodiments, the apparatus may comprise a tube having a volume of no more than 2000 cm³, an inner swirler configured to direct a first gas to flow in a first tangential direction within the tube, an outer configured to direct a second gas to flow in an opposed second tangential direction within the tube, and a fuel distributor configured to distribute fuel between the first gas flow and the second gas flow.

The apparatus, in yet another set of embodiments, comprises a cylindrical tube, an inner swirler configured to direct a first gas to flow in a first tangential direction within the tube, centered on a longitudinal axis of the tube, an outer swirler configured to direct a second gas to flow in an opposed second tangential direction within the tube, centered on a longitudinal axis of the tube, a fuel distributor configured to distribute fuel between the first gas flow and the second gas flow, and a heater positioned to heat at least a portion of the fuel distributor.

In still another set of embodiments, the apparatus comprises a tube having an outlet, an inner swirler configured to direct a first gas to flow in a first tangential direction within the tube and in a longitudinal direction towards the outlet, an outer swirler configured to direct a second gas to flow in an opposed second tangential direction within the tube and in a longitudinal direction towards the outlet, and a recuperator configured to alter a direction of flow of gases exiting the tube at the outlet, in a direction towards the inner swirler and the outer swirler.

The apparatus, in another set of embodiments, comprises a tube having an outlet, an inner swirler configured to direct a first gas to flow in a first tangential direction within the tube and in a longitudinal direction towards the outlet, an outer swirler configured to direct a second gas to flow in an opposed second tangential direction within the tube and in a longitudinal direction towards the outlet, and a recuperator for passing heat from gases exiting the tube at the outlet to the first gas entering the inner swirler and/or the second gas entering the outer swirler.

In yet another set of embodiments, the apparatus comprises a tube having an inlet and an outlet, a recuperator configured to alter a direction of flow of gases exiting the tube at the outlet, in a direction towards the inlet, and a photonic crystal external to the tube.

In addition, some aspects are generally directed to a method. In accordance with one set of embodiments, the method comprises swirling a first gas in a first tangential direction as the first gas flows longitudinally in a tube, swirling a second gas in an opposed second tangential direction as the second gas flows longitudinally in a tube, flowing a liquid fuel between the first gas and the second gas within the tube, and igniting the fuel by heating the fuel to a temperature greater than the autoignition temperature of the fuel.

In another set of embodiments, the method comprises vaporizing a fuel to produce a vaporized fuel; passing the vaporized fuel between a first gas and a second gas within a tube, the first gas flowing in a first direction and the second gas flowing in an opposed second direction; heating the vaporized fuel to a temperature of at least 1000° C.; oxidizing the fuel to produce a heated exhaust; and exposing a thermal power generator to the heated exhaust.

The method, in yet another set of embodiments, comprises atomizing a liquid fuel to produce a atomized fuel having an average diameter of less than 25 micrometers; passing the atomized fuel between a first gas and a second gas within a tube, the first gas flowing in a first direction and the second gas flowing in an opposed second direction; heating the atomized fuel to a temperature of at least 300° C.; oxidizing the fuel to produce a heated exhaust; and exposing a thermal power generator to the heated exhaust.

According to still another set of embodiments, the method comprises flowing fuel into a tube at a flow rate of less than 15 ml/min, flowing air into the tube at a flow rate such that oxygen within the air is present at more than 10 mol % or 25 mol % over the stochiometric amount of oxygen that completely oxidize the fuel, completely oxidizing at least 90 mol % of the fuel within the tube to produce a heated exhaust, and exposing a photonic crystal to electromagnetic radiation from the heated exhaust.

The method, in another set of embodiments, comprises flowing fuel into a tube at a flow rate of less than 10 ml/min, flowing air into the tube, heating the fuel to a temperature of at least 1000° C., oxidizing the fuel using oxygen in the air to produce a heated exhaust, and using the heated exhaust to heat the air before flowing the air into the tube.

In another set of embodiments, the method comprises passing a vaporized fuel between a first gas flowing in a first direction and a second gas flowing in a second, opposed direction, and heating the fuel to a temperature greater than the autoignition temperature of the fuel.

Yet another aspect is generally directed to a method comprising vaporizing a fuel and/or flowing a fuel at a flow rate of less than 15 ml/min and/or atomizing a fuel to produce a atomized fuel having an average droplet diameter of less than 25 micrometers, heating the fuel to a temperature of at least 300° C. and/or igniting the fuel by heating the fuel to a temperature greater than the autoignition temperature of the fuel, oxidizing the fuel and/or exposing the fuel to a heated gas containing no more than 25 mol % over the stochiometric amount of oxygen that completely oxidize the fuel and/or flowing the fuel between a heated first gas and a heated second gas, to produce a heated exhaust, and exposing a thermal power generator to the heated exhaust and/or producing power using the heated exhaust and/or heating a gas using the heated exhaust.

In another aspect, the present disclosure encompasses methods of making one or more of the embodiments described herein, for example, a fuel burner. In still another aspect, the present disclosure encompasses methods of using one or more of the embodiments described herein, for example, a fuel burner.

Other advantages and novel features of the present disclosure will become apparent from the following detailed description of various non-limiting embodiments of the disclosure when considered in conjunction with the accompanying figures.

### BRIEF DESCRIPTION OF THE DRAWINGS

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1 is a schematic diagram of an apparatus in accordance with one embodiment;

FIG. 2 is a schematic diagram of an apparatus in accordance with another embodiment;

FIG. 3 is a schematic diagram of an apparatus comprising a recuperator, in still another embodiment;

FIG. 4 is a schematic diagram illustrating an apparatus comprising a photovoltaic cell array, in yet another embodiment;

FIG. 5 illustrates mixing of gas and fuel, in yet another embodiment; and

FIG. 6 is a schematic diagram of an apparatus in another embodiment.

### DETAILED DESCRIPTION

The present disclosure generally relates to fuel burners, for example, for use with photonic crystals as part of thermophotovoltaic power generators or with other thermal power generators. In certain aspects, fuel is supplied into a reaction tube and mixed between swirling streams of gases moving in opposite directions (e.g., clockwise and counterclockwise) within the tube. This may allow for rapid mixing and relatively complete oxidation or combustion of the fuel. Heat may be extracted from the heated exhaust and may be supplied to a thermal power generator to produce power. For example, the heat may be supplied to an emitter comprising a photonic crystal, which can be used to direct electromagnetic radiation to a thermophotovoltaic cell to produce power. In addition, certain embodiments are directed to relatively small burners, e.g., that can burn fuel at less than 20 ml/min to produce power. Other aspects are generally directed to various combustion methods for such burners, methods of making or using such burners, kits involving such burners, or the like.

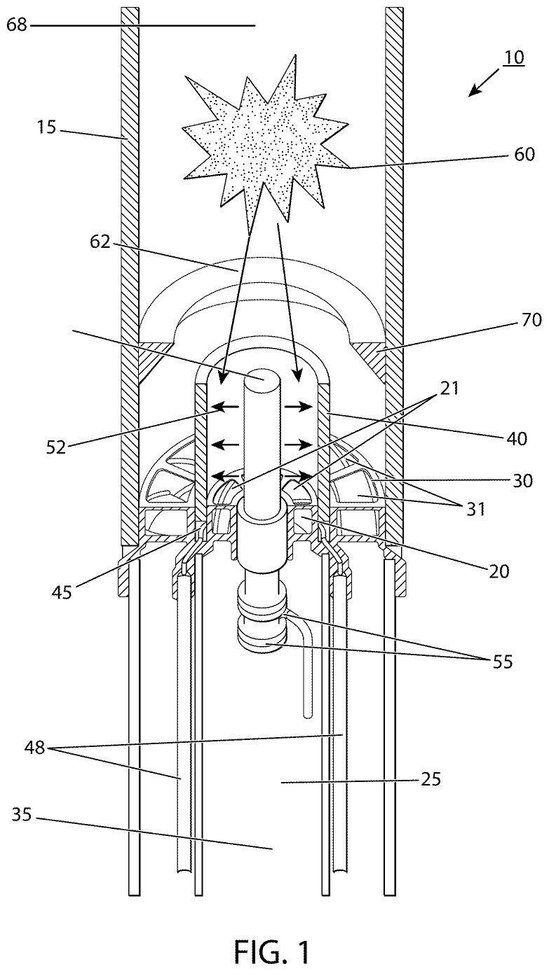

One non-limiting example of a burner apparatus is now discussed with reference to FIG. 1, in accordance with one aspect. In this figure, apparatus 10 includes a tube 15, in which gases (e.g., air or oxygen) and fuel (e.g., kerosene, jet fuels such as JP-8, etc.) are introduced and reacted. The fuel may be oxidized or “burned” to produce waste gases and heat. As discussed herein, in accordance with certain embodiments, the gas and fuel are well-mixed, allowing most of the fuel entering the burner to be completely oxidized (for example, producing waste gases such as CO₂ and H₂O, as well as heat). In contrast, incomplete oxidation of the fuel typically results in carbon particles (e.g., soot, coke, etc.), unreacted or incompletely reacted fuel, CO production, and other waste products that limit the efficiency of the burner. In addition, in certain embodiments, the gases are introduced such that a relatively low amount of oxygen is provided, e.g., to limit the amount of oxygen that is not reacted by oxidation with the fuel.

In one set of embodiments, two streams of gases are introduced into the tube in opposed directions (e.g., clockwise and counterclockwise). The gases may be the same or different, and may arise from the same or different sources. The gases may be introduced concentrically, for example, using inner swirler 20 and outer swirler 30. In this figure, inner swirler 20 and outer swirler 30 each comprise a number of orifices 21, 31, through which gas may be introduced. In FIG. 1, the orifices are circumferentially positioned in a spaced relationship around the tube, although other arrangements are possible. The swirlers may be configured to cause the exiting gases to flow in a preferred direction (e.g., clockwise and counterclockwise) using a variety of techniques such as vanes, fins, baffles, or the like. In this way, two streams of gases flow or “swirl” in opposed directions about the tube as the gases move downstream or longitudinally down the tube.

In addition, in this figure, inner swirler 20 and outer swirler 30 are fed by gas supply channels 25 and 35, respectively. Gas supply channel 25 flows through the center of tube 15, while gas supply channel 35 is circumferentially positioned at the periphery of tube 15, although other configurations are also possible in other embodiments. Gas may be urged into the apparatus, for example, using one or more fans (not shown) or other suitable devices, and the gases directed to the swirlers may come from the same source or different sources.

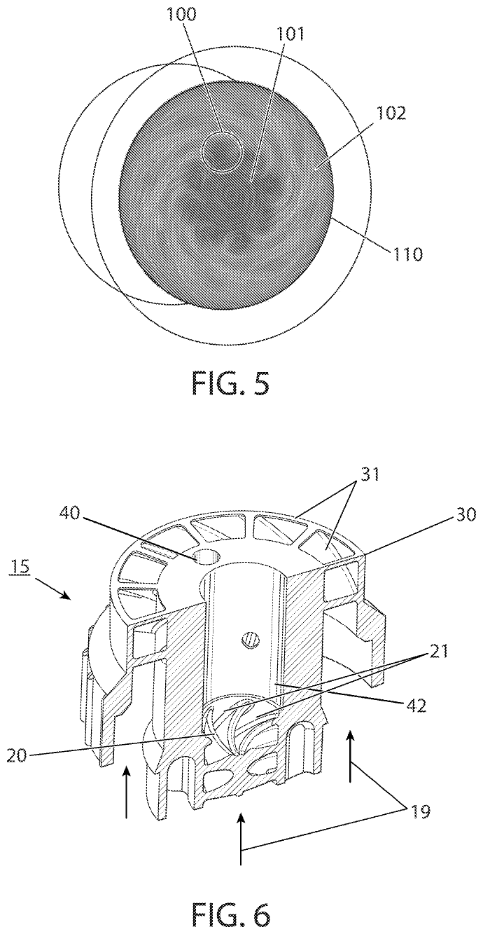

Fuel can also be introduced between the first gas and the second gas. This may cause rapid mixing of the fuel due to the interactions of the fuel with the first gas and the second gas. For instance, in some cases, the interactions of the fuel and gases may lead to the creation of eddies, such as is shown in FIG. 5 with eddy 100, in between first gas 101 and second gas 102 flowing in opposed directions within a cross-sectional view of tube 110.

In addition, in some cases, the mixing of gas and fuel may be facilitated by the presence of one or more constrictions, such as constriction 70 within tube 15 as is shown in FIG. 1. Without wishing to be bound by any theory, it is believed that the constructions may force the gas and fuel to become more closely associated together and/or increase turbulence. However, it should be understood that such constrictions are not always required to be present.

The fuel is introduced into tube 15 via fuel distributor 40. In this example, fuel distributor has a form of a cylinder, and is formed out of a porous medium, for example, sintered stainless steel particles. Fuel distributor 40 is centrally aligned within tube 15, and is concentrically positioned between inner swirler 20 and the outer swirler 30 positioned to distribute fuel between the first gas and the second gas from each respective swirler. In this figure, fuel may be delivered into fuel distributor 40 using fuel distribution channel 45, which is positioned to delivery fuel substantially uniformly to the bottom edge of the fuel distributor. For example, as shown in this figure, fuel distribution channel 45 has a generally circular configuration about the base of the fuel distributor, and is fed via a plurality of fuel channels 48. In this figure, two such fuel channels are shown, although there may be more or fewer fuel channels present. Fuel may be urged through fuel channels from a suitable fuel source, e.g., using a pump (not shown) or other suitable devices.

In certain embodiments, the fuel may be heated within the tube, e.g., to a temperature sufficient to ignite the fuel, e.g., to cause the fuel to react with oxygen in order to oxidize or combust (or “burn”) the fuel. The fuel may be heated, for example, due to the temperature of the incoming first gas and the second gas, and/or due to the heat produced by the oxidation reactions occurring within the tube. Such reactions are often exothermic, producing heat, as well as exhaust gases such as CO, CO₂, H₂O, NOₓ, SOₓ, etc., depend on the type of fuel. In some cases, as mentioned, the fuel may be completely oxidized, i.e., the gases that are produced are in a fully oxidized state (e.g., H₂O, CO₂, etc.). In addition, the flow of fuel and air into the tube cause the reaction or oxidation of the fuel to occur in a downstream direction away from the fuel distributor and the swirlers. Thus, for example, as is shown schematically in FIG. 1, oxidation of the fuel occurs in region 60, in a downstream direction along tube 15, and exit tube 15 via outlet 68.

In some cases, the fuel may be autoignited, i.e., the reaction of the fuel with oxygen can occur without an ignition source to initiate the reaction, such as a spark from a spark plug. Accordingly, in some embodiments, the apparatus may lack an ignition source. Instead, the fuel may be raised to a temperature such that the ignition of the reaction occurs spontaneously. For example, the autoignition temperature of Jet A-1 fuel is about 210° C. Thus, for instance, as is shown in FIG. 1, radiation from region 60 may be used to heat fuel distributed by the fuel distributor, as is shown by radiation 62. It should be noted that the temperature of the fuel may rise as the fuel leaves the fuel distributor (for example, by heating by radiation within the tube, and/or by the temperature of the incoming gases. For example, this process may occur as the fuel travels downstream to region 60.

Thus, in certain embodiments, the fuel may ignite relatively close to the fuel distributor. For example, the fuel may autoignite within 20 cm, within 15 cm, within 10 cm, or within 5 cm of the fuel distributor, e.g., in the upstream or downstream direction.

In addition, in some embodiments, a heater may be used to initially heat the fuel, for example, to start the autoignition process. However, once autoignition has started, the heater may also be deactivated in certain embodiments, as no more heat is required to continue the oxidation reaction (although in other embodiments, a heater may be used even after autoignition of the fuel has started). Thus, as a non-limiting example, in FIG. 1, heater 50 can be used to heat the fuel distributor and the fuel distributed by it. In this example, heater 50 may be an electric heater, such as a glow plug, which radiates heat to the fuel distributor as shown by radiation 52. Electricity can be supplied to the electric heater via electrical connections 55. However, it should be understood that in other embodiments, other sources of heat may also be used.

The heated gases may be used to provide heat to a suitable thermal power generator and used to produce power. Examples include thermoelectric generators or thermionic generators. As another example, in some cases, the heat may be used to provide heat to an emitter that emits electromagnetic radiation, which can be directed at a thermophotovoltaic cell to produce power. In some cases, the emitter may also include a photonic crystal, e.g., as discussed in U.S. Pat. No. 9,116,537, incorporated by reference in its entierty for all purposes. In addition, in some embodiments, the heated gases may be used to heat incoming gases, e.g., using a recuperator or a heat exchanger.

An example of this is now described with respect to FIG. 2. This figure is a side profile of apparatus 10. Apparatus 10 includes an inlet 80 where air is drawn into the apparatus as indicated by arrow 88, for example, using a fan or other suitable device, for example, into one or more gas supply channels. The air flows through recuperator 90, and is heated by exhaust gases travelling in a countercurrent direction to one or more exhaust outlets 85. The air then flows into chamber 15. Chamber 15 may be a tube or other reaction chamber. For instance, chamber 15 may have a structure such as shown in FIG. 1, in which the heated air drawn in from inlet 80 is introduced into chamber 15 using a plurality of swirlers.

As discussed, the air may be reacted with a fuel to produce exhaust gases. These exhaust gases exit outlet 68 of chamber 15. Since apparatus 10 is sealed at this end, the gases are routed in an opposed direction, e.g., back towards exhaust outlets 85, as indicated by arrows 95. On the way towards exhaust outlets 85, the exhaust gases pass back through recuperator 90 and thereby heat the air flowing into the tube, as previously discussed.

As mentioned, the heat from the reaction may be used to heat a suitable thermal power generator to produce power. As a non-limiting example, in this figure, photonic crystal 99 is heated from the reaction. The photonic crystal may be part of an emitter that emits electromagnetic radiation, which can be directed at a thermophotovoltaic cell to produce power. Accordingly, by drawing air in through inlet 80 and reacting it with a fuel, heat may be produced and used to generate power.

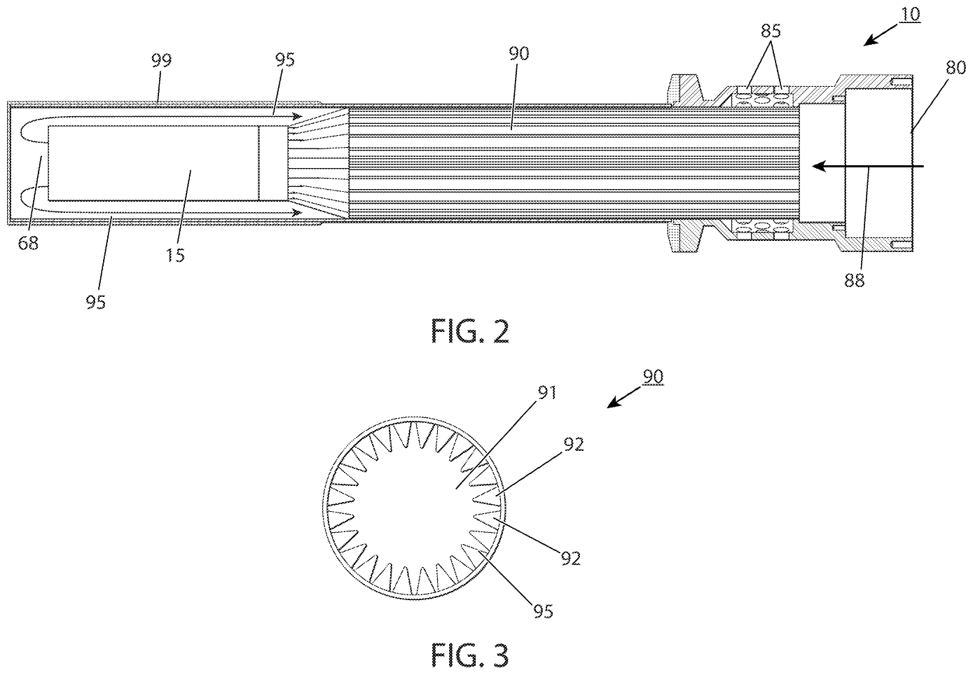

FIG. 3 illustrates a cross-section of one non-limiting example of a recuperator. This recuperator may be used in the apparatus shown in FIG. 2, or another apparatus. In this figure, incoming air flows into recuperator 90 through channel 91, while exhaust gases flow out through channels 92. These are separated by wall 95, which may be, for example, a foil, a metal, or made out of materials that exhibit high heat conductivities. The flow of gases within recuperator 90 may be countercurrent, e.g., such that the recuperator acts as a heat exchanger. Accordingly, as incoming gases flow through the recuperator, they can be heated by exhaust gases exiting the recuperator.

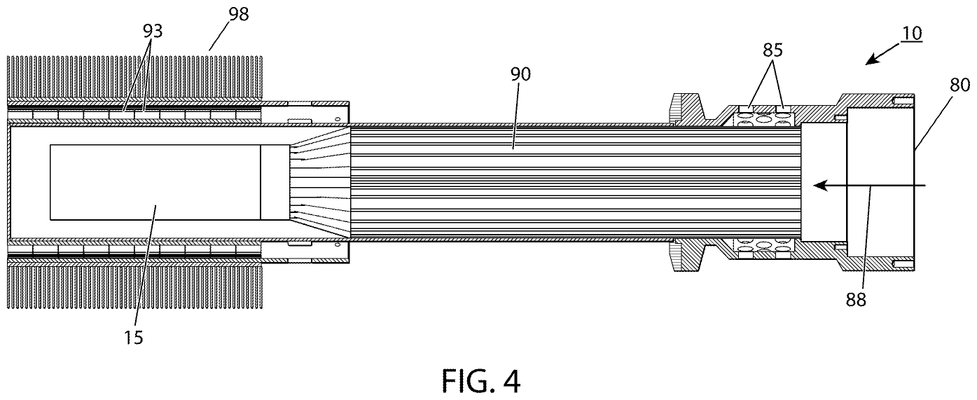

FIG. 4 illustrates another apparatus 10, similar to the one illustrated in FIG. 3, but further comprising an array of a thermophotovoltaic cells 93 for receiving electromagnetic radiation produced by an emitter. In addition, in this figure, a heat sink 98 is provided to dissipate some of the heat received by the thermophotovoltaic cells.

The above discussion is a non-limiting example of one embodiment of the present invention generally directed to a fuel burner for producing power. However, other embodiments are also possible. Accordingly, more generally, various aspects of the invention are directed to various systems and methods for fuel burners for producing power.

Thus, certain aspects are generally directed to fuel burners where gases such as air are mixed with a fuel to produce heat, where the heat can be used to produce power, e.g., using a suitable thermal power generator.

For example, in one set of embodiments, a fuel burner apparatus may comprise a tube into which gases and fuel are introduced and caused to react with each other, e.g., in a combustion or oxidation reaction (e.g., such that the fuel is “burned”). The tube may, in some embodiments, be substantially cylindrical and/or have a substantially circular cross section. Although a tube is described in accordance with certain embodiments, the fuel burner apparatus may also comprise other reaction chambers having configurations other than a tube in other embodiments; for example, the reaction chamber may have the shape of a sphere or a box. As a specific non-limiting example, a spherical configuration may be useful to minimize heat losses due to oxidation of the fuel.

In some cases, the tube may be relatively small. Such tubes may be useful, for example, in certain applications where relatively smaller amounts of power are required, e.g., between 10 W and 100 kW. Such power production may be useful, for requirements that fall between batteries and internal combustion engines.

For example, in one set of embodiments, the tube (or other reaction chambers) may have a volume of no more than 100,000 cm³, no more than 50,000 cm³, no more than 30,000 cm³, no more than 200,000 cm³, no more than 10,000 cm³, no more than 5,000 cm³, no more than 3,000 cm³, no more than 20,000 cm³, no more than 10,000 cm³, no more than 5,000 cm³, no more than 3,000 cm³, no more than 2,000 cm³, no more than 1000 cm³, or no more than 500 cm³, etc. (1000 cm³=1 liter.) Such volumes are much smaller than the engines found, for example, on jet airplanes, which are typically measured on the order of tens of cubic meters (m³).

In addition, in some cases, the tube may have an inner diameter of less than 15 cm, less than 10 cm, or less than 5 cm. In some embodiments, the tube may have a length of less than 100 cm, less than 80 cm, less than 70 cm, less than 60 cm, less than 50 cm, less than 40 cm, less than 30 cm, or less than 25 cm. In addition, in some embodiments, the tube may have a constant cross-sectional diameter or area, and/or the tube may have a cross-sectional diameter or area that varies. For example, in some cases, the tube may taper to smaller dimensions or flare to larger dimensions towards downstream portions of the tube. In addition, in some embodiments, the tube may have one or more constrictions, e.g., to facilitate the mixing of gases within the tube.

The tube may comprise any suitable material. In some embodiments, the tube is constructed from materials able to withstand reaction temperatures of at least 210° C., at least 300° C., at least 600° C., at least 1000° C., at least 1100° C., at least 1200° C., or other temperatures such as those described herein. Non-limiting examples of suitable materials include Inconel® or nickel-chromium-based superalloys, Hastelloy® or nickel alloys, Kanthal® or iron-chromium-aluminum (FeCrAl) alloys, stainless steel, or other suitable metals, e.g., aluminum, nickel, titanium, etc. and/or alloys of these and/or other metals.

For example, in one set of embodiments, the tube may comprise Inconel® or another metal superalloy, for example, an austenitic nickel-chromium-based superalloy. Non-limiting examples include Inconel® 625, Inconel® 617, Inconel® 690, Inconel® 600, Inconel® 718, or Inconel® X-750. In some cases, the tube may comprise an alloy of nickel and chromium, optionally including other metals or materials, such as iron, molybdenum, niobium, tantalum, cobalt, manganese, copper, aluminum, titanium, silicon, carbon, sulfur, phosphorous, boron, etc. According to some embodiments, the tube may comprise at least 90% of a metal superalloy.

In one set of embodiments, one or more gases are passed into the tube or other reaction chamber. The gases may include air, oxygen, or other suitable gases, and may arise from a suitable source of gas, including the atmosphere or a tank of gas. Oxygen within the gases may be used to react or combust fuel in a combustion or oxidation reaction.

In some cases, a first gas and a second gas are introduced. The gases may be compositionally identical or different, and may arise from a single source of gas (e.g., the atmosphere), or more than one source of gas. In addition, in certain cases, more than 2 gases may be introduced, e.g., into a tube or other reaction chamber.

Gases may be delivered at any volumetric or linear flow rates, in accordance with one set of embodiments. If more than one gas is introduced, the gases may be introduced at the same velocity or volumetric flow rates, or different velocities or volumetric flow rates. In some embodiments, a gas may be introduced into the tube at a linear flow rate of less than 300 m/s, less than 200 m/s, less than 150 m/s, less than 100 m/s, less than 50 m/s, less than 30 m/s, less than 20 m/s, less than 10 m/s, less than 5 m/s, less than 3 m/s, less than 2 m/s, less than 1 m/s, less than 0.8 m/s, less than 0.7 m/s, less than 0.6 m/s, less than 0.5 m/s, less than 0.4 m/s, less than 0.3 m/s, less than 0.2 m/s, etc. In addition, in some cases, a gas may introduced at a flow rate of at least 0.2 m/s, at least 0.3 m/s, at least 0.4 m/s, at least 0.5 m/s, at least 0.6 m/s, at least 0.7 m/s, at least 0.8 m/s, at least 1 m/s, at least 2 m/s, at least 3 m/s, at least 5 m/s, at least 10 m/s, at least 20 m/s, at least 30 m/s, at least 50 m/s, at least 100 m/s, at least 150 m/s, at least 200 m/s, or at least 300 m/s. Combinations of any of these are also possible in certain embodiments; for example, the linear flow rate of between 3 m/s and 5 m/s, between 1 m/s and 10 m/s, between 50 m/s and 100 m/s, or the like.

In some cases, a gas may be introduced into the tube at a flow rate of at least 10 L/min, at least 20 L/min, at least 30 L/min, at least 40 L/min, at least 50 L/min, at least 60 L/min, at least 70 L/min, at least 80 L/min, at least 90 L/min, at least 100 L/min, at least 110 L/min, at least 120 L/min, at least 130 L/min, at least 140 L/min, at least 150 L/min, etc. In addition, in some cases, the gas may be introduced at a flow rate of no more than 150 L/min, no more than 140 L/min, no more than 130 L/min, no more than 120 L/min, no more than 110 L/min, no more than 100 L/min, no more than 90 L/min, no more than 80 L/min, no more than 70 L/min, no more than 60 L/min, no more than 50 L/min, no more than 40 L/min, no more than 30 L/min, no more than 20 L/min, no more than 10 L/min, etc. In addition, combinations of any of these ranges are also possible in certain cases.

In some embodiments, a gas may be heated, e.g., as discussed herein. For example, a gas may enter a tube (or other reaction chamber) at a temperature of at least 100° C., at least 200° C., at least 300° C., at least 400° C., at least 500° C., at least 600° C., at least 700° C., at least 800° C., at least 900° C., at least 1000° C., at least 1100° C., at least 1200° C., at least 1300° C., at least 1400° C., at least 1500° C., etc. In addition, in certain embodiments, a gas may be pressurized, e.g., to cause the gas to flow into the tube. For instance, the gas may be pressurized to pressures of at least 100 Pa, at least 125 Pa, at least 150 Pa, at least 200 Pa, at least 250 Pa, at least 300 Pa, at least 350 Pa, at least 400 Pa, at least 450 Pa, at least 500 Pa, etc., e.g., upon entry into the tube or other reaction chamber. (These pressures are gauge pressures.)

In one set of embodiments, the tube may have one or more constrictions, e.g., where the tube decreases in cross-sectional area. For instance, the area within the constriction may decrease by at least 10%, at least 20%, at least 30%, at least 40%, at least 50%, etc., e.g., as compared to the cross-sectional area of the tube outside of the constriction. As other examples, in some embodiments, the constriction may reduce the cross-sectional inner diameter of the tube by at least 1 mm, at least 2 mm, at least 3 mm, at least 5 mm, at least 1 cm, at least 2 cm, at least 3 cm, at least 4 cm, at least 5 cm, etc.

Constrictions, in some embodiments, may be upstream or downstream of the locations where gas enters (e.g., swirlers) and/or where fuel enters (e.g., a fuel distributor). In some cases, the constriction may be at least 1 cm, at least 2 cm, at least 3 cm, at least 4 cm, at least 5 cm, at least 10 cm, at least 20 cm, at least 30 cm, at least 50 cm, or at least 100 cm of a swirler and/or a fuel distributor within a tube. In addition, in some cases, the constriction may be within 100 cm, within 50 cm, within 30 cm, within 20 cm, within 10 cm, within 5 cm, within 3 cm, within 2 cm, or within 1 cm of a swirler and/or a fuel distributor within a tube. Combinations of any of these are also possible. For example, the constriction may be between 10 cm to 50 cm, or between 2 cm and 20 cm of the swirler and/or a fuel distributor.

As non-limiting examples, the constriction may have a relatively abrupt change in cross-sectional area, and/or the constriction may be tapered in some fashion (for example, as in a Venturi tube). The constriction may be useful in certain cases to facilitate the mixing of gases within the tube, for example, by causing gases and/or fuel within the tube to come closer together and/or mix. One non-limiting example of a constriction is constriction 70 in FIG. 1. However, it should be understood that the constriction may allow at least some gases to pass through, e.g., the constriction should not be so narrow as to substantially prevent any gases from passing through the constriction.

The first and/or second gases may be introduced, in one set of embodiments, in a “swirling” trajectory, for example, such that the gases have a longitudinal velocity component (e.g., flowing down the tube towards an outlet) and a tangential velocity component (e.g., flowing around a center longitudinal axis of the tube). Thus, for example, a gas May generally be directed to flow in a spiral of substantially constant radius.

The amount of “swirling” may be quantified in some cases using a Swirl Number, which is a ratio of the radial velocity component to the longitudinal velocity component. For example, in some embodiments, a gas may be introduced at a Swirl Number of at least 0.3, at least 0.4, at least 0.5, at least 0.6, at least 0.7, at least 0.75, at least 0.8, at least 0.9, at least 1, at least 1.25, at least 1.5, etc. In some cases, a gas may be introduced at a Swirl Number of no more than 3, no more than 2.5, no more than 2, no more than 1.5, no more than 1.25, no more than 1, no more than 0.9, no more than 0.8, no more than 0.75, no more than 0.7, no more than 0.6, or no more than 0.5, etc. Combinations of these are also possible in certain embodiments, e.g., the Swirl Number may be between 0.3 and 0.5, between 0.4 and 0.7, between 0.5 and 1.0, etc.

A gas introduced into the tube may be directed to flow in a clockwise manner or a counterclockwise manner, e.g., as the gas flows longitudinally down the tube. If two gases are introduced, they may be directed to flow in opposed directions, i.e., a first gas may flow in a clockwise direction while a second gas may flow in a counterclockwise direction, or vice versa.

Thus, in accordance with one set of embodiments, a gas may be directed to flow in a swirling trajectory using one or more swirlers. For example, a swirler may be configured to direct a gas to flow at a swirl trajectory or a Swirl Number such as discussed herein. Two or more swirlers may be present in some embodiments, for example, an inner swirler for swirling a first gas and an outer swirler for swirling a second gas. The swirlers may independently be the same or different.

For example, in certain embodiments, a swirler may comprise one or more orifices through which gas can enter into the tube. These can take the form of openings, nozzles, or the like. In some cases, they may be in a spaced configuration, e.g., circumferentially around the tube. The orifices may be evenly spaced in some embodiments, for example, in a circular configuration. In some cases, the swirler may be positioned within the tube, e.g., in a center region of the tube, or such that the swirler is centered on the center longitudinal axis of the tube. If more than one swirler is present, they may have coplanar orifices or other openings, or ones that are not coplanar.

As a non-limiting example of a swirler, in FIG. 6, a cutaway example of a generally cylindrical manifold 15 is shown, including an inner swirler 20 and an outer swirler 30. In this figure, inner swirler 20 comprises a plurality of orifices 21, while outer swirler 30 comprises a plurality of orifices 31. The number of orifices may be the same or different, and the sizes of the orifices may be the same or different, e.g., as is shown in this particular example. For example, a swirler may have 1, 2, 3, 4, 5, 6, 7, 8, 9, 10, 11, 12, or more orifices, depending on the embodiment. Gases may be introduced into the swirlers (for example, as is shown with arrows 19 in this figure, indicating gases being directed to the swirlers to be urged into the tube or other reaction chamber). In some cases, the gases may delivered to the swirlers using one or more gas supply channels, which may be in fluidic communication with one or more sources of gas.

In some cases, mechanical components may be used to direct the flow of gases exiting the orifices, e.g., in a swirling trajectory. For instance, the swirlers may include components such as baffles, vanes, fins, panels, nozzles, or the like to direct gases exiting the swirlers into the tube in a swirling trajectory. For example, one of more of these may be angled, e.g., to direct the flow of gas in a preferential direction (e.g., clockwise or counterclockwise) as the gas flows in a downstream direction.

In certain embodiments, a swirler may be contained within the tube (or other reaction chamber). In some embodiments, a swirler may be integrally formed with the tube. For example, the tube and swirler may be formed using techniques such as injection molding or 3D-printing, which may result in a unitary manifold that comprises one or more swirlers and a tube or other reaction chamber. In other embodiments, however, one or more of the swirlers may not be integrally formed with the tube. For instance, a swirler may be formed from a different material than the tube. In addition, the swirler may be formed from any suitable material. As one example, a swirler may be formed from a metal, e.g., aluminum, nickel, titanium, etc. and/or alloys of these and/or other metals. As another example, a swirler may be formed from a ceramic, such as HfB₂, ZrB₂, HfN, ZrN, TiC, TiN, ThO₂, TaC, SiC, HfC, NbC, ZrC, TiB₂, NbB₂, TaB₂, ZrN, VC, TaN, NbN, VN, or the like.

In one set of embodiments, gases such as air may be supplied to the swirlers using one or more gas supply tubes. A non-limiting example are gas supply tubes 35 and 25 in FIG. 1. Any number of gas supply tubes may be present, depending on the application. In some cases, if more than one swirler is present, gas may be supplied to the swirlers using different gas supply tubes, or using a common supply tubes. In addition, the gases may arise from different gas sources, or from a common gas source. In one embodiment, the gas source is the atmosphere, e.g., the air surrounding the device. However, in other embodiments, other gases may be used, in addition and/or instead of air. For example, gases supplied to the swirler include, but are not limited to, oxygen, nitrox, oxygen-enriched air or other gases (e.g., air or another gas having greater than 21 vol % oxygen), etc. The gases that are supplied may come from a tank or cylinder of gas, or any other suitable source. In addition, in some cases, a fan or other suitable device may be used to move a gas to a swirler. One or more than one fan or other device may be used, e.g., to supply gas to an inner swirler and an outer swirler, etc.

Oxygen within the gas may react with a fuel, e.g., in an oxidation or combustion reaction, in accordance with one set of embodiments. Thus, the fuel may be “burned” in oxygen, e.g., producing heat and exhaust gases (which may be produced by partially or fully oxidizing the fuel). The fuel may include any suitable fuel that can be oxidized or otherwise reacted to produce heat, for example, via oxidation or other suitable chemical reactions. Examples of fuel include, but are not limited to, gasoline, ethanol, diesel, petroleum, naphtha, hydrogen, propane, methane, coal gas, water gas, or the like. Additional non-limiting examples of fuel include heavy fuels, such as diesel, jet fuel, kerosene, or the like. Specific non-limiting examples of jet fuel include JP-8, Jet A-1, Jet-A, JP-4, Jet B, TS-1, JP-1, JP-2, JP-3, JP-5, JP-6, JP-7, JP-9, JP-10, JPTS, Zip fuel, syntroleum, or the like.

The fuel may be partially or completely oxidized in certain embodiments. In some cases, e.g., as discussed herein, the fuel may be well-mixed with the gases, allowing most of the fuel to be completely oxidized, e.g., producing exhaust or waste gases that are in a highly oxidized state, e.g., CO₂, H₂O, SO₂, or the like. This may allow a relatively larger amount of heat to be produced by oxidizing the fuel, as well as producing a more efficient reaction. However, in other embodiments, the fuel may be only partially oxidized, which may result in the production of exhaust gases that are not fully oxidized (e.g., CO, hydroxides, acetaldehyde, etc.). In some cases, incomplete oxidation of fuel may lead to the production of carbon particles (e.g., soot, coke, etc.), unreacted or incompletely reacted fuel, etc. In certain embodiments, at least 30 mol %, at least 50 mol %, at least 60 mol %, at least 70 mol %, at least 75 mol %, at least 80 mol %, at least 85 mol %, at least 90 mol %, or at least 95% of the fuel is completely oxidized.

In some embodiments, the fuel and/or gas (e.g., a first gas and a second gas) are introduced in an oxygen-rich or fuel-lean manner, e.g., that there is an excess of oxygen compared to fuel. Thus, for example, if the fuel were to be completely combusted or oxidized, there would be no more fuel left but there would be some oxygen left. In some embodiments, fuel and gas are introduced such that oxygen within the gas is present at no more than 60 mol %, no more than 50 mol %, no more than 40 mol %, no more than 30 mol %, no more than 25 mol %, no more than 20 mol %, no more than 15 mol %, no more than 10 mol %, or no more than 5 mol % over the stoichiometric amount of oxygen that would completely oxidize the fuel. However, in some cases, the fuel and/or gas (e.g., a first gas and a second gas) are introduced in an oxygen-lean or fuel-rich manner, e.g., such that the fuel is present at no more than 60 mol %, no more than 50 mol %, no more than 40 mol %, no more than 30 mol %, no more than 25 mol %, no more than 20 mol %, no more than 15 mol %, no more than 10 mol %, or no more than 5 mol % over the stoichiometric amount of oxygen that would completely oxidize the fuel.

In one set of embodiments, the fuel may be delivered at relatively low flow rates, e.g., using a pump as described herein. This may be useful for certain applications, for example, in relatively small or portable burners. (In other embodiments, however, higher fuel delivery flow rates may be used.) For example, in certain cases, fuel may be delivered at a flowrate of no more than 100 ml/min, no more than 50 ml/min, no more than 30 ml/min, no more than 20 ml/min, no more than 15 ml/min, no more than 10 ml/min, no more than 5 ml/min, no more than 3 ml/min, no more than 2 ml/min, or no more than 1 ml/min. The fuel may also be delivered at rates of at least 1 ml/min, at least 2 ml/min, at least 3 ml/min, at least 5 ml/min, at least 10 ml/min, at least 15 ml/min, at least 20 ml/min, at least 30 ml/min, at least 50 ml/min, or at least 100 ml/min. Combinations of any of these are also possible in certain cases.

The fuel may be introduced into the tube (or other reaction chamber) using a fuel distributor, in one set of embodiments. A non-limiting example of a fuel distributor is shown in FIG. 1. In addition, more than one fuel distributor may be present in some cases. In some cases, the fuel distributor may be configured to distribute fuel into the tube, e.g., into a region between the first gas and the second gas within the tube. For instance, the fuel distributor may be positioned within the tube, e.g., in a center region of the tube, or positioned between an inner swirler and an outer swirler. In some cases, the fuel distributor is centered on the center longitudinal axis of the tube. A non-limiting examples of a fuel distributor is fuel distributor 40 in FIG. 6, which may comprise a porous medium 42 in this example.

In some cases, the fuel distributor may be have a generally cylindrical or tube-shaped configuration, e.g., to separate an inner swirler and an outer swirler. The fuel distributor may be coplanar with the inner swirler and/or the outer swirler, or in some cases, the fuel distributor is not coplanar with either. The fuel distributor may distribute fuel in a variety of directions, e.g., radially inwardly and/or radially outwardly and/or longitudinally or downstream. This may be useful, for example, to facilitate mixing of the fuel with gas from the inner swirler and/or gas from the outer swirler. Thus, in some cases, the flow of such gases and fuels may be turbulent, which may facilitate mixing.

In some embodiments, the fuel distributor may have a cross-sectional wall thickness of at least 1 mm, at least 2 mm, at least 3 mm, at least 5 mm, at least 1 cm, at least 2 cm, at least 3 cm, or at least 5 cm. In some cases, the wall thickness may be no more than 10 cm, no more than 5 cm, no more than 3 cm, no more than 2 cm, no more than 1 cm, no more than 5 mm, no more than 3 mm, no more than 2 mm, or no more than 1 mm. Combinations of any of these are also possible, e.g., the thickness may be between 1 cm and 3 cm, between 2 mm and 5 mm, etc.

In some embodiments, the fuel distributor may include a porous medium. Without wishing to be bound by any theory, it is believed that the porous medium in a fuel distributor may allow fuel to be relatively homogeneously and evenly distributed, e.g., between the first and second gas. The porosity of the porous medium may be useful to reduce or prevent “clogging,” e.g., due to incomplete oxidation of fuel before it leaves the fuel distributor. For instance, even if a few pores are blocked within the fuel distributor, there will be other pathways available for the fuel to be distributed out of the fuel distributor.

In some cases, the porous medium may have a porosity sufficient to allow a liquid and/or vaporized fuel to flow through the medium, e.g., to be distributed within the tube. The porous medium may have an open-cell structure. In certain embodiments, the porous medium may have an average pore size or diameter of at least 1 micrometer, at least 2 micrometers, at least 3 micrometers, at least 5 micrometers, at least 10 micrometers, at least 20 micrometers, at least 30 micrometers, at least 50 micrometers, at least 100 micrometers, at least 200 micrometers, etc. In addition, in some case, the pore size or diameter may be no more than 500 micrometers, no more than 300 micrometers, no more than 200 micrometers, no more than 100 micrometers, no more than 50 micrometers, no more than 30 micrometers, no more than 20 micrometers, no more than 10 micrometers, no more than 5 micrometers, no more than 3 micrometers, no more than 2 micrometers, no more than 1 micrometer, etc. In addition, in certain cases, combinations of any of these are possible. For example, the porous medium may have an average pore size of between 1 micrometer and 10 micrometers, between 3 micrometers and 100 micrometers, or the like.

The porous medium, in certain embodiments, can be constructed from materials able to withstand reaction temperatures of at least 210° C., at least 300° C., at least 600° C., at least 1000° C., at least 1100° C., or other temperatures such as those described herein. Non-limiting examples of porous media include sintered stainless steel, sintered Inconel® or nickel-chromium-based superalloys, sintered titanium, or the like, or ceramics such as silica, silicates, aluminosilicates, diatomites, corundums, silicon carbide (SiC), ocordierite, Al₂O₃, Si₃N₄, YB₄, YbB₆, ZrO₂, ZrB₂, Al₂TiO₅, or the like. In some cases, more than one such material may be present within a porous medium, e.g., a mixture of ZrB₂ and SiC, or Al₂O₃ and Al₂TiO₅. In some cases, the porous medium may comprise metal screens or wires, which may be layered in certain embodiments. In one set of embodiments, the porous medium may be 3D-printed.

In certain embodiments, a fuel distributor may be contained within the tube (or other reaction chamber). In some embodiments, a fuel distributor may be integrally formed with the tube. For example, in some embodiments, the fuel distributor may be formed using techniques such as injection molding or 3D-printing, which may result in a unitary manifold that comprises a fuel distributor contained within a tube or other reaction chamber (and in some embodiments, with swirlers or other components, such as those described herein). In other embodiments, however, the fuel distributor may not be integrally formed with the tube.

However, it should be understood that other fuel distributor configurations are also possible, and that a porous medium is not necessarily required. For example, in another set of embodiments, a fuel distributor may include a plurality of orifices through which fuel can enter into the tube. These can take the form of openings, nozzles, or the like. In some cases, these may be in a spaced configuration, e.g., circumferentially around the tube. The orifices may be evenly spaced in some embodiments, for example, in a circular configuration.

In one set of embodiments, the fuel may be heated to at least the boiling point of the fuel, which may facilitate the conversion of fuel into a gas or a vapor state, which may allow the fuel to enter a gaseous state, e.g., between two or more gases within the tube (or other reaction chambers). For example, the fuel may be heated to a temperature of at least 100° C., at least 150° C., at least 200° C., at least 250° C., at least 300° C., at least 350° C., etc.

However, it should be understood that the fuel need not be in a gaseous state. For example, in some embodiments, the fuel may be delivered into the tube as liquid droplets, e.g., by atomizing the fuel. In some cases, such droplets are sufficiently small to be suspended within the gas. For example, the fuel may be present as droplets having an average droplet diameter of less than 1 mm, less than 500 micrometers, less than 300 micrometers, less than 100 micrometers, less than 50 micrometers, less than 30 micrometers, less than 25 micrometers, less than 10 micrometers, less than 5 micrometers, less than 3 micrometers, less than 1 micrometer, etc.

In addition, in certain cases, the fuel may be heated to a temperature greater than the autoignition temperature of the fuel, or at least one component of the fuel. As non-limiting examples, the autoignition temperature of Jet A-1 fuel is about 210° C., while the autoignition temperature of kerosene is about 295° C. and the autoignition temperature of JP-8 is about 257° C., and in certain cases, the fuel may be heated to a temperature greater than these temperatures, depending on the type of fuel. Accordingly, the fuel may be reacted with oxygen without first coming into contact with an ignition source, such as a spark from a spark plug. Instead, by heating the fuel, for example, using heat from gas within or entering the tube, the fuel may be oxidized.

Thus, the heat needed to vaporize or autoignite the fuel may be supplied from a variety of sources. For instance, in one example, the gases entering the tube may enter at a temperature that is greater than the boiling point of the fuel. In another example, heat may be supplied to the fuel, e.g., before the fuel enters the fuel distributor, and/or when the fuel is in the fuel distributor. As a specific non-limiting example, an electric heater may be used to supply heat to the fuel and/or to the fuel distributor, at least initially to start an oxidation reaction involving the fuel, such as is discussed herein.

Thus, in accordance with one set of embodiments, the tube may contain a heater that is positioned to heat at least a portion of the fuel and/or the fuel distributor. The heater may be positioned in any suitable location, e.g., within the tube. For example, the heater may be positioned in the center of the fuel distributor, or in a center region of the tube, e.g., such that the heater is centered on the center longitudinal axis of the tube.

Any suitable type of heater may be used. In one embodiment, the heater may be an electric heater, for example, a glow plug. In another embodiment, the heater may produce heat by reacting fuel. In yet another embodiment, the heater may produce heat via a chemical reaction. In addition, it should be understood that the heater need not be run continuously (although it can be in certain embodiments). In other embodiments, however, the heater may be shut off once fuel has been heated to a temperature at least sufficient to autoignite the fuel. In some cases, for example, after autoignition, the oxidation of fuel may produce sufficient heat to heat the incoming fuel to a temperature greater than its autoiginition temperature. Accordingly, such an oxidation reaction may be self-sustaining in certain embodiments, e.g., so long as sufficient air and/or fuel are provided to the reaction.

Fuel may be supplied to the distributor using a suitable fuel supply, in accordance with one set of embodiments. The fuel supply may be in fluidic communication with the fuel distributor, for example, using one or more distribution channels, one or more fuel channels, or the like. The fuel supply may move fuel from a fuel source into a fuel distributor in an apparatus such as discussed herein. In some cases, one or pumps may be used to move fuel from the source of fuel into the fuel distributor, e.g., as discussed herein.

Thus, for example, in one set of embodiments, one or more distribution channels may be used to supply fuel to the fuel distributor. In some cases, the distribution channels may be positioned under the fuel distributor, e.g., in contact with the base or circumference of the fuel distributor, e.g., so as to be able to distribute fuel to the fuel distributor. Fuel passing through the distribution channels can thus enter the fuel distributor to be delivered into the tube. The distribution channels may be positioned to distribute fuel to the fuel distributor, for example, radially. In some cases, the distribution channel may have a general circular shape, e.g., if the fuel distributor has a generally cylindrical or tube-shaped configuration.

In addition, in some cases, the fuel source may also include one or more fuel channels connecting a source of fuel to the distribution channel and/or the fuel distributor. For example, in some cases, the fuel channels may pass longitudinally through the tube to reach the distribution channel and/or the fuel distributor. A non-limiting example are fuel channels 48 in FIG. 1. The source of fuel may be a tank or other container for containing the fuel. The tank may be made from any suitable material able to contain the fuel. In some cases, the tank may be pressurized, e.g., at a pressure greater than atmospheric pressure. For instance, the fuel may be at a pressure (gauge) of at least 5 kPa, at least 10 kPa, at least 15 kPa, at least 20 kPa, at least 30 kPa, at least 40 kPa, at least 50 kPa, at least 75 kPa, at least 100 kPa, at least 150 kPa, at least 200 kPa, etc.

The fuel supply may also contain one or more pumps that are used to deliver fuel from a source of fuel to the fuel distributor. A variety of pumps may be used, for example, mechanical pumps, diaphragm pumps, plunger-type pumps, electric pumps, port pumps, helix pumps, turbopumps, centrifugal pumps, axial-flow pumps, or the like.

In one set of embodiments, after reaction of fuel with oxygen (e.g., in air and/or other gases introduced into the tube or other reaction chambers), heat and/or exhaust gases are produced. In some cases, such heated exhaust or waste gases may be relatively hot, e.g., having temperatures of at least 800° C., at least 900° C., at least 1000° C., at least 1100° C., at least 1200° C., at least 1300° C., at least 1400° C., at least 1500° C., etc. Such heated exhaust or waste gases may flow longitudinally within the tube, e.g., towards an outlet, for example, to be discharged to the atmosphere as waste gases. However, in some cases, the heat may be at least partially recovered or recuperated, and used to heat incoming gases and/or fuel, e.g., using a recuperator.

In certain embodiments, the gases flowing longitudinally or downstream towards an outlet of a tube may be redirected using a recuperator, e.g., such that the gas flows in an upstream direction towards an inlet of the tube where gases entered. In certain cases, the recuperator may be radially symmetric, e.g., with respect to the center longitudinal axis of the tube, although in some cases, the recuperator may not necessarily be radially symmetric.

In some cases, the recuperator may direct the heated exhaust towards the incoming gases and/or fuel, e.g., such that heat may be exchanged from the heated exhaust towards the incoming gases and/or fuel. For instance, the recuperator may include a heat exchanger, such as a countercurrent heat exchanger, a parallel flow heat exchanger a perpendicular flow heat exchanger, etc., to exchange heat, e.g., to a first gas and/or a second gas. For example, the recuperator may have the form of a shell-and-tube heat exchanger, or the recuperator may have one or more inlet channels and one or more outlet channels, separated by a wall, a foil, or other materials. For example, the material may be one that exhibit high heat conductivities, for example, copper, aluminum, stainless steel, carbon steel, chromium, titanium, cupronickel, etc.

In some cases, the heat exchanged may be sufficient to increase the temperature of the incoming gas to a temperature of at least 100° C., at least 200° C., at least 300° C., at least 400° C., at least 500° C., at least 600° C., at least 700° C., at least 800° C., at least 900° C., at least 1000° C., etc. In addition, in some cases, the heat exchanged may be sufficient to increase the temperature of the incoming gas to a temperature that is able to heat the incoming fuel to a temperature greater than its autoignition temperature, e.g., as discussed herein.

In one set of embodiments, heat produced as discussed herein may be used to produce power. For instance, heat may be supplied to a thermoelectric generator or a thermionic generator, and used to produce power. A thermoelectric generator may comprise one or more thermoelectric materials, such as Bi₂Te₃, Bi₂Se₃, Si/Ge, Te/Sb/Ge/Ag (TAGS), etc. and be able to convert differences in temperature directly into electrical energy. A thermionic generator may comprise an electrode that can be heated to thermionically emit electrons. In some cases, the thermionic generator may comprise cesium vapor or other suitable materials.

As another example, heat as discussed herein may be supplied to an emitter, which can generate electromagnetic radiation within one or more predetermined ranges of wavelengths when heated. For example, the emitter may be positioned within the tube and heated by chemical reactions occurring within the tube. Not wishing to be bound by any particular theory, the electromagnetic radiation may be emitted due to changes to the electromagnetic properties of the emitter surface. Heating the emitter to relatively high temperatures (e.g., as discussed herein) may allow it to produce electromagnetic radiation that can be converted into electricity by a thermophotovoltaic (TPV) cell.

The emitter can be constructed and arranged such that it emits electromagnetic radiation within one or more predetermined ranges while internally reflecting certain wavelengths within the emitter volume. For example, in some embodiments, a relatively large percentage of the electromagnetic radiation (e.g., at least about 50%, at least about 75%, or at least about 90%) emitted by the emitter can have an energy higher than the electronic band gap of the TPV cell used in the system.

A photonic crystal may be associated with the emitter to achieve selective emission of electromagnetic radiation from the emitter, in some embodiments. Those of ordinary skill in the art would be familiar with photonic crystals, which include periodic optical structures that allow certain wavelengths of electromagnetic radiation to be propagated through the photonic crystal structure, while other wavelengths of electromagnetic radiation are confined within the volume of the photonic crystal. This phenomenon is generally referred to in the art as a photonic band gap. The photonic crystal can be fabricated directly on the emitter or fabricated separately and integrated with the emitter as a separate step.

The photonic crystal associated with the emitter can have, in some cases, 1-dimensional periodicity. One of ordinary skill in the art would be able to determine the dimensionality of the periodicity of a photonic crystal upon inspection. For example, 1-dimensionally periodic photonic crystals include materials arranged in such a way that the index of refraction within the volume of the photonic crystal varies along one coordinate direction and does not substantially vary along two orthogonal coordinate directions. For example, a 1-dimensionally periodic photonic crystal can include two or more materials arranged in a stack within the emitter such that there is substantially no variation in the index of refraction along two orthogonal coordinate directions. 2-dimensionally periodic photonic crystals include materials arranged in such a way that the index of refraction within the volume of the photonic crystal varies along two coordinate directions and does not substantially vary along 1 coordinate direction orthogonal to the other two coordinate directions.

Any suitable materials can be used to form an emitter. For example, the emitter can comprise a semiconductor (e.g., silicon, germanium), a metal (e.g., tungsten), a dielectric material (e.g., titanium dioxide, silicon carbide) and the like. In some embodiments, all or part of the emitter can be made from a refractory metal (e.g., niobium, molybdenum, tantalum, tungsten, osmium, iridium, ruthenium, zirconium, titanium, vanadium, chromium, rhodium, hafnium, and/or rhenium) and/or another refractory material. The use of refractory materials can allow one to fabricate an emitter that is capable of withstanding relatively high temperatures (e.g., at least about 1000° C., at least about 1500° C., or at least about 2000° C.). In some embodiments, all or part of the emitter can be made of compounds such as tungsten carbide, tantalum hafnium carbide, and/or tungsten boride. In some embodiments, all or part of the emitter can be made from noble metals, including noble metals with high melting points (e.g., platinum, palladium, gold, and silver), diamond, and/or cermets (e.g., compound metamaterials including two or more materials (e.g., tungsten and alumina) which can be, in some embodiments, broken up into pieces smaller than the wavelength of visible light). In some embodiments, all or part of the emitter can be made from a combination of two or more of these materials.

The emitter can also include photonic crystal in certain embodiments. The photonic crystal, in some embodiments, may include a first material with a first index of refraction proximate a base, a second material with a second index of refraction between the base and the first material, and a third material with a third index of refraction between the base and the second material. Additional layers are also possible in some embodiments.

In some embodiments, the materials within a 1-dimensionally periodic photonic crystal can be arranged such that the material occupying the outermost surface of the photonic crystal has the lowest index of refraction of the photonic crystal materials. The indices of refraction of the materials can, in some cases, increase along a path starting at the outermost surface of the photonic crystal and extending toward the base of the emitter. In some cases, the index of refraction of the second material can be at least about 1.1, at least about 1.5, at least about 2, between about 1.1 and about 2, or between 1.1 and about 1.5 times greater than the index of refraction of the first material. The index of refraction of the third material can be, in some embodiments, at least about 1.1, at least about 1.5, at least about 2, between about 1.1 and about 2, or between 1.1 and about 1.5 times greater than the index of refraction of the second material. Fourth, fifth, sixth, and subsequent materials, positioned between the first three layers and the base can have indices of refraction that are progressively higher than those of preceding material. In some embodiments, the indices of refraction of the materials within the 1-dimensionally periodic photonic crystal can increase exponentially along a path starting at the outermost surface of the photonic crystal and extending toward the base of the emitter. Arranging the materials of the photonic crystal in this manner can enhance the degree to which desirable wavelengths of electromagnetic radiation are emitted from the emitter, while reducing the degree to which unwanted wavelengths are emitted.

In some embodiments, the photonic crystal can comprise an integer number of m materials (e.g., m layers of materials) labeled such that the material given an index of i=1 is closest to the base and farthest from the emission surface and the material given an index of i=m (i.e., the m^{th} material) is closest to the emission surface (e.g., the outermost surface of the photonic crystal). One of ordinary skill in the art would understand that, when counting the number of photonic crystal materials, materials that do not contribute to the bandgap function of the photonic crystal would not be counted. For example, an adhesion layer between photonic crystal layers would not be counted.

In some cases, the photonic crystal may include a plurality of bi-layers. In some embodiments, the bi-layer farthest from the base (or closest to the emission surface) has the shortest period, while the bi-layer closest to the base (or farthest from the emission surface) has the longest period. In some cases, the 1-dimensionally periodic photonic crystal can be constructed such that the periods of the bi-layers increase substantially exponentially in a direction from the bi-layer farthest from the base (or closest to the emission surface) to the bi-layer closest to the base (or farthest from the emission surface). For example, in some embodiments, the photonic crystal can include m bi-layers numbered from the bi-layer closest to the emission surface to the bi-layer farthest from the emission surface.

The 1-dimensionally periodic photonic crystals described above can include a variety of suitable types of materials. Examples of materials suitable for use in the 1-dimensionally periodic photonic crystals include, but are not limited to, silicon, silicon dioxide, silicon nitride, metals (e.g., steel, tungsten, tantalum, platinum, palladium, silver, gold, etc.), metal oxides (e.g., alumina, zirconia, titania), cermets (e.g., aluminum based cermets such as Ni-Al₂O₃ cermets), and the like. As one specific example, the 1-dimensionally periodic photonic crystal can comprise bi-layers, each bi-layer containing a layer of silicon and a layer of silicon dioxide. As another specific example, the 1-dimensionally periodic photonic crystal can comprise a plurality of layers of tungsten-silica cermet and/or a plurality of layers of tungsten-alumina cermet.

In some embodiments, the photonic crystal may include layers of material adjacent the top surface of a base. These layers can be formed as thin films (e.g., films with average thicknesses of less than about 100 microns and, in some cases, less than about 10 microns, or less than about 1 micron). In some cases, it can be advantageous for the photonic crystal to be positioned over the entire external surface of the emitter to prevent unwanted wavelengths of electromagnetic radiation from being emitted. However, it should be understood that, in other embodiments, the materials within the photonic crystal might not be formed as layers, and might not be positioned over the entire external surface of the emitter. For example, the TPV cell might have a smaller exposed surface area than the external surface area of the emitter, in which case, the photonic crystal might only occupy a portion of the emitter surface while the rest of the emitter surface is coated with a material constructed and arranged to reflect substantially all of the electromagnetic radiation generated by the emitter.

As used herein, two materials (e.g., layers of materials) are “proximate” when they are sufficiently close to retain their desired functionality. In some embodiments, two materials can be proximate when they are positioned in direct contact with each other. In some instances, two materials can be proximate while one or more other materials are positioned between them.

In some embodiments, the photonic crystal associated with the emitter can include 2-dimensional periodicity. The 2-dimensionally periodic photonic crystals can include any suitable type of material. Examples of materials that can be used to form the 2-dimensionally periodic photonic crystal include, but are not limited to, metals (e.g., tungsten (e.g., single-crystal tungsten), tantalum, platinum, palladium, silver, gold, etc.), semiconductors (e.g., silicon, germanium, etc.), or dielectrics (e.g., titania, zirconia).

In some embodiments, all or part of the 1-dimensionally periodic photonic crystal and/or the 2-dimensionally periodic photonic crystal can be made from a refractory metal (e.g., niobium, molybdenum, tantalum, tungsten, osmium, iridium, ruthenium, zirconium, titanium, vanadium, chromium, rhodium, hafnium, and/or rhenium) and/or another refractory material. The use of refractory materials can allow one to fabricate a photonic crystal that is capable of withstanding relatively high temperatures (e.g., at least about 1000° C., at least about 1500° C., or at least about 2000° C.). In some embodiments, all or part of the 1-dimensionally periodic photonic crystal and/or the 2-dimensionally periodic photonic crystal can be made of compounds such as tungsten carbide, tantalum hafnium carbide, and/or tungsten boride. In some embodiments, all or part of the 1-dimensionally periodic photonic crystal and/or the 2-dimensionally periodic photonic crystal can be made from noble metals, including noble metals with high melting points (e.g., platinum, palladium, gold, and silver), diamond, and/or cermets (i.e., compound metamaterials including two or more materials (e.g., tungsten and alumina) which can be, in some embodiments, broken up into pieces smaller than the wavelength of visible light). In some embodiments, all or part of the 1-dimensionally periodic photonic crystal and/or the 2-dimensionally periodic photonic crystal can be made from a combination of two or more of these materials.

Electromagnetic radiation produced by the emitter may be directed to a thermophotovoltaic cell. The electromagnetic radiation may impinge the emitter as photons, which can be subsequently converted into electron-hole pairs within a photovoltaic (PV) medium. These electron-hole pairs can be conducted to leads within the apparatus to produce a current. Because they are solid-state devices, TPV systems have the potential for relatively high reliabilities, relatively small form factors (e.g., meso-and micro-scales), and relatively high energy densities compared to, for example, traditional mechanical engines.

In some cases, one or more thermophotovoltaic cells may be present. A thermophotovoltaic cell may be constructed and arranged to convert at least a portion of the electromagnetic radiation emitted by the emitter into energy. In some cases, a filter, which can be independent of the photonic crystal associated with the emitter, can be placed between the emitter and a thermophotovoltaic cell. The filter can be constructed and arranged such that certain wavelengths are transmitted from the emitter, through the filter, and to the thermophotovoltaic cell, while other wavelengths are reflected from the filter back toward the emitter.

The filter can comprise, in some instances, a photonic crystal including 1-dimensional periodicity. The design of the filter can include any of the properties described above with respect to the 1-dimensionally periodic photonic crystal associated with the selective emitter. In some embodiments, the selective emitter and the filter can be constructed and arranged such that the selective emitter suppresses the emission of a first range of wavelengths of electromagnetic radiation and the filter reflects a second range of wavelengths of electromagnetic radiation such that a third range of wavelengths of electromagnetic radiation is incident on a TPV cell. As a specific example, the emitter can be constructed and arranged such that at least about 90%, at least about 95%, or at least about 99% of the electromagnetic radiation emitted by the emitter has a wavelength of less than about 3 microns or between about 4.5 microns and about 7 microns. In some such cases, the filter can be constructed and arranged to reflect at least about 90%, at least about 95%, or at least about 99% of the electromagnetic radiation with a wavelength of between about 4.5 microns and about 7 microns.

In some embodiments, a voltage can be applied to the thermophotovoltaic cell to increase the power generated by the thermophotovoltaic cell. This voltage can be adjusted, in some embodiments, as the appratus is operated to enhance the amount of power generated by the appartus. In many applications, the intensity of the electromagnetic radiation emitted from the emitter can vary with time, which can affect the amount of current generated by a thermophotovoltaic cell. By adjusting the voltage applied to the thermophotovoltaic cell, one can increase the net amount of power produced within certain embodiments of the apparatus. In addition, in some embodiments, voltages applied to a plurality of thermophotovoltaic cells can be controlled independently, allowing one to account for variabilities in the amount of incident electromagnetic radiation across an array of cells.

A variety of TPV cells are suitable for use. In some embodiments, the TPV cell(s) can have a low bandgap (e.g., less than about 1.0 eV). The TPV cell(s) can include any suitable material such as, for example, GaInAsSb (e.g., InGaAsSb on GaSb), Zn-diffused GaSb, Ge, InGaAs (e.g., InGaAs on InP), and the like. Moreoever, individual TPV cell(s) can be of any suitable size, and multiple TPV cells can be arranged to form an array of any suitable size. For example, in some embodiments, the TPV cells (e.g., a single TPV cell, or a TPV cell within an array) can be constructed and arranged to produce no more than about 15 W, no more than about 5 W, no more than about 1 W, no more than about 100 mW, or between about 10 mW and about 15 W of power. One of ordinary skill in the art would be capable of selecting an appropriate TPV cell and arranging multiple cells in an appropriately sized array for a given power generation application.

In some embodiments, a voltage can be applied to the TPV cell(s) to increase the power output by the TPV cell(s). The efficiency of the TPV system can be improved, in some embodiments, by adjusting the voltage applied to the TPV cell(s). In many instances, the power produced by the TPV cell can vary depending on the voltage applied to the TPV cell. The voltage at which the maximum power can be extracted can change with changes in operating conditions such as incident irradiation and cell junction temperature. In some cases, the TPV generation system can include one or more controllers that can be used to determine an applied voltage at which power generation is enhanced.

In some embodiments, the control system can be used to alter (e.g., increase or decrease) the voltage applied to the TPV cell(s). After the applied voltage is altered, the power produced by the TPV cell(s) can be determined (e.g., by measuring the current flowing through and/or the voltage applied to the TPV cell(s)). The controller can then, in some instances, determine whether the power produced by the TPV cell(s) increased or decreased in response to the change in applied voltage. In some such embodiments, if the power produced by the TPV cell(s) increases, the applied voltage may be further increased (e.g., when the preceding adjustment was an increase in applied voltage) or further decreased (e.g., when the preceding adjustment was a decrease in applied voltage), for example, until the power produced decreases. In some such cases, if the power produced by the TPV cell(s) decreases upon altering the applied voltage, then the applied voltage may be altered in the opposite direction relative to the previous change. (e.g., decreased when the preceding change was an increase in applied voltage, increased when the preceding change was a decrease in applied voltage). A maximum power output point can be located, after which the applied voltage may stabilize, where it can oscillate, for example, within a range of voltages the magnitude of which can be twice the magnitude of the voltage adjustment steps. In some embodiments, the controller can determine the initial starting applied voltage by performing a sweep of applied voltages upon starting operation of the TPV cell, and recording the applied voltage corresponding to the maximum output power observed.

In some instances, the voltages applied across multiple TPV cells can be altered independently. For example, a first voltage applied to a first TPV cell (e.g., using a first controller) can be altered independently from a second voltage applied to a second TPV cell (e.g., using a second controller). Accordingly, in some cases, the voltage applied to the first TPV cell can be increased by the first controller while the voltage applied to the second TPV cell can be decreased by the second controller, or vice versa. In other cases, the first and second applied voltages can both be increased or decreased. In some embodiments, third, fourth, fifth, or more voltages applied to third, fourth, fifth, or more TPV cells can be independently altered. The ability to independently alter the voltages applied to multiple TPV cells can be useful in enhancing the total amount of power generated by the collection of cells. For example, in many TPV applications, the irradiation of the TPV cell array can be non-uniform. This may occur, for example, if the TPV cell array is positioned relatively far from the emitter and/or if the distance between the TPV cell array and the emitter changes. In addition, the temperature distribution across the burner surface can be non-uniform. This can lead to situations in which one TPV cell in the array has a photocurrent that is larger than the other photocurrents in the other TPV cells in the array. The TPV cells with relatively high photocurrents can produce relatively more current than the TPV cells with relatively low photocurrents. However, for many applications, the total current extracted from the array may be limited to the current produced in the least irradiated cell. In some such cases, the other cells (with relatively high photocurrents) can operate at a cell current that is below their peak current, resulting in a total output power that may be substantially lower than the maximum achievable power. However, if the applied voltages to each of the cells are altered independently, the power produced by each cell can be independently enhanced, leading to an overall enhancement of the total power generated by the array.

Communication between the TPV cell(s) and the controllers (e.g., to transmit a signal indicating the desired applied voltage, to measure current, to measure power, etc.) can be achieved using any suitable method. The communication links can be wired or wireless, and one of ordinary skill in the art would be capable of selecting an appropriate communication link for a given application.

In some cases, the TPV cell(s) may be kept at cooler temperatures, which may be useful, for example, to provide more optimal power generation. For instance, in certain embodiments, the TPV cell(s) may be kept to temperatures below 80° C., for instance, between 40° C. and 60° C. In some embodiments, one or more cooling devices may be used to facilitate control of the temperature of the TPV cell(s). For example, heat sinks, Peltier coolers, or the like may be used. A non-limiting example is the heat sink 98 shown in FIG. 4. The heat sink may be active and passive, and may be formed out of a variety of materials, for example, aluminum or copper. In some cases, for example, the heat sink may include a plurality of fins, ribs, or other thermally conductive members.

The apparatuses and methods described herein can be used in a variety of applications. In some cases, as a non-limiting example, the apparatuses and methods described herein can be used in conjunction with microthermophotovoltaic systems, which can be useful for powering portable electronics devices such as cell phones, laptop computers, and the like. Additional details of such photonic crystals, filters, control systems, emitters, etc. may be seen in U.S. Pat. No. 9,116,537, incorporated by reference in its entierty for all purposes.

In addition, U.S. Provisional Patent Application Ser. No. 63/339,617, filed May 9, 2022, entitled “Rapid Mixing Systems and Methods for Fuel Burners,” by Chan, et al., is incorporated herein by reference in its entirety.

The following examples are intended to illustrate certain embodiments of the present disclosure, but do not exemplify the full scope of the disclosure.

### Example 1

This example illustrates one embodiment of an apparatus, e.g., as is shown in FIG. 1. In this example, fuel was pumped at a rate of 2 mL/min into a cylinder formed from a porous media that was electrically heated to 300° C., where it was vaporized. The vapor was swept downstream by a first swirling air stream. After exiting the swirler, the first air stream interacted with a second swirling air stream rotating in the opposite direction, resulting in rapid fuel/air mixing. The interaction was aided by a constriction. The fuel/air mixture was ignited by an electric spark. The vane pitch on the inner and outer swirlers as well as the flow split was set such that enough net swirl remains to provide flame stabilization through a centerline recirculation zone. The total air flow (sum of the inner and outer air streams) was set at 120% of the stoichiometric air flow.

The hot exhaust products heated the back side of the photonic crystal emitter to 1000° C. to 1100° C., then the products entered the recuperator where they heated the incoming air to 400° C. to 700° C. During steady state operation, the porous media was maintained at its operating temperature by balancing the heat gain from the preheated air and the heat loss from fuel vaporization.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the word “about” is used herein in reference to a number, it should be understood that still another embodiment of the disclosure includes that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An apparatus, comprising:
a tube;
an inner swirler configured to direct a first gas to flow in a first tangential direction within the tube;
an outer swirler configured to direct a second gas to flow in an opposed second tangential direction within the tube;
a fuel distributor configured to distribute fuel between the first gas flow and the second gas flow; and
a thermal power generator positioned to receive heat produced by a reaction of the fuel within the tube.

2. The apparatus of claim 1, wherein the tube has an inner diameter less than 10 cm.

3. The apparatus of any one of claim 1 or 2, wherein the tube has an inner diameter less than 5 cm.

4. The apparatus of any one of claims 1-3, wherein the tube has a volume of no more than 1000 cm³.

5. The apparatus of any one of claims 1-4, wherein the tube has a length of no more than 50 cm.

6. The apparatus of any one of claims 1-5, wherein the tube has a length of no more than 40 cm.

7. The apparatus of any one of claims 1-6, wherein the tube comprises stainless steel.

8. The apparatus of any one of claims 1-7, wherein the tube comprises Inconel® 625.

9. The apparatus of any one of claims 1-8, wherein the tube comprises Kanthal®.

10. The apparatus of any one of claims 1-9, wherein the tube is substantially cylindrical.

11. The apparatus of any one of claims 1-10, wherein the tube has a circular cross section.

12. The apparatus of any one of claims 1-11, wherein the tube further comprises a constriction.

13. The apparatus of claim 12, wherein the constriction reduces a cross-sectional area of the tube by at least 20%.

14. The apparatus of any one of claim 12 or 13, wherein the constriction reduces a cross-sectional area of the tube by at least 30%.

15. The apparatus of any one of claim 12 or 14, wherein the constriction reduces a cross-sectional area of the tube by at least 40%.

16. The apparatus of any one of claims 12-15, wherein the constriction reduces a cross-sectional inner diameter of the tube by at least 2 cm.

17. The apparatus of any one of claims 12-16, wherein the constriction reduces a cross-sectional inner diameter of the tube by at least 5 cm.

18. The apparatus of any one of claims 12-17, wherein the constriction is positioned downstream of the fuel distributor.

19. The apparatus of any one of claims 12-18, wherein the constriction is positioned upstream of the fuel distributor.

20. The apparatus of any one of claims 12-19, wherein the constriction is positioned within 5 cm of a portion of the fuel distributor.

21. The apparatus of any one of claims 12-20, wherein the tube has a substantially constant cross section downstream of the constriction.

22. The apparatus of any one of claims 1-21, wherein the inner swirler comprises a plurality of orifices.

23. The apparatus of claim 22, wherein the plurality of orifices are spaced in a circular arrangement.

24. The apparatus of any one of claims 1-23, wherein the inner swirler is contained within the tube.

25. The apparatus of any one of claims 1-24, wherein the inner swirler is integrally formed with the tube.

26. The apparatus of any one of claims 1-25, wherein the inner swirler is centered on the center longitudinal axis of the tube.

27. The apparatus of any one of claims 1-26, wherein the inner swirler comprises a plurality of angled vanes.

28. The apparatus of any one of claims 1-27, wherein the inner swirler comprises a plurality of angled fins.

29. The apparatus of any one of claims 1-28, wherein the inner swirler comprises a plurality of angled nozzles.

30. The apparatus of any one of claims 1-29, wherein the inner swirler is configured to direct the first gas to flow within the tube at a Swirl Number of at least 0.5.

31. The apparatus of any one of claims 1-30, wherein the inner swirler is configured to direct the first gas to flow within the tube at a Swirl Number of at least 0.75.

32. The apparatus of any one of claims 1-31, wherein the inner swirler is configured to direct the first gas to flow within the tube at a Swirl Number of at least 1.

33. The apparatus of any one of claims 1-32, wherein the inner swirler is configured to direct the first gas to flow within the tube at a Swirl Number of no more than 3.

34. The apparatus of any one of claims 1-33, wherein the inner swirler is configured to direct the first gas to flow within the tube at a Swirl Number of no more than 2.

35. The apparatus of any one of claims 1-34, wherein the inner swirler is configured to direct the first gas clockwise within the tube in a downstream direction.

36. The apparatus of any one of claims 1-35, wherein the inner swirler is configured to direct the first gas counterclockwise within the tube in a downstream direction.

37. The apparatus of any one of claims 1-36, wherein the inner swirler is configured to direct the first gas to flow in a longitudinal direction within the tube.

38. The apparatus of any one of claims 1-37, wherein the outer swirler comprises a plurality of orifices.

39. The apparatus of claim 38, wherein the plurality of orifices are spaced in a circular arrangement.

40. The apparatus of any one of claim 38 or 39, wherein the plurality of orifices are spaced circumferentially around the tube.

41. The apparatus of any one of claims 1-40, wherein the outer swirler is contained within the tube.

42. The apparatus of any one of claims 1-41, wherein the outer swirler is integrally formed with the tube.

43. The apparatus of any one of claims 1-42, wherein the outer swirler is centered on the center longitudinal axis of the tube.

44. The apparatus of any one of claims 1-43, wherein the outer swirler comprises a plurality of angled vanes.

45. The apparatus of any one of claims 1-44, wherein the outer swirler comprises a plurality of angled fins.

46. The apparatus of any one of claims 1-45, wherein the outer swirler comprises a plurality of angled nozzles.

47. The apparatus of any one of claims 1-46, wherein the outer swirler is configured to direct the first gas to flow within the tube at a Swirl Number of at least 0.5.

48. The apparatus of any one of claims 1-47, wherein the outer swirler is configured to direct the first gas to flow within the tube at a Swirl Number of at least 0.75.

49. The apparatus of any one of claims 1-48, wherein the outer swirler is configured to direct the first gas to flow within the tube at a Swirl Number of at least 1.

50. The apparatus of any one of claims 1-49, wherein the outer swirler is configured to direct the first gas to flow within the tube at a Swirl Number of no more than 3.

51. The apparatus of any one of claims 1-50, wherein the outer swirler is configured to direct the first gas to flow within the tube at a Swirl Number of no more than 2.

52. The apparatus of any one of claims 1-51, wherein the outer swirler is configured to direct the second gas clockwise within the tube in a downstream direction.

53. The apparatus of any one of claims 1-52, wherein the outer swirler is configured to direct the second gas counterclockwise within the tube in a downstream direction.

54. The apparatus of any one of claims 1-53, wherein the outer swirler is configured to direct the second gas to flow in a longitudinal direction within the tube.

55. The apparatus of any one of claims 1-54, wherein the inner swirler and the outer swirler are coplanar.

56. The apparatus of any one of claims 1-55, wherein the inner swirler and the outer swirler are not coplanar.

57. The apparatus of any one of claims 1-56, further comprising a fan configured to urge the first gas through the inner swirler.

58. The apparatus of claim 57, wherein the fan is configured to urge the second gas through the outer swirler.

59. The apparatus of any one of claim 57 or 58, further comprising a second fan configured to urge the second gas through the outer swirler.

60. The apparatus of any one of claims 1-59, wherein the first gas is air.

61. The apparatus of any one of claims 1-60, wherein the second gas is air.

62. The apparatus of any one of claims 1-61, wherein the first gas and the second gas are compositionally identical.

63. The apparatus of any one of claims 1-62, wherein the fuel distributor comprises a porous medium.

64. The apparatus of claim 63, wherein the porous medium has an average pore diameter of at least a micrometer.

65. The apparatus of any one of claim 63 or 64, wherein the porous medium has an average pore diameter of at least 10 micrometers.

66. The apparatus of any one of claims 63-65, wherein the porous medium has an average pore diameter of no more than 5 mm.

67. The apparatus of any one of claims 63-66, wherein the porous medium comprises sintered metal particles.

68. The apparatus of any one of claims 63-67, wherein the porous medium comprises sintered ceramic particles.

69. The apparatus of any one of claims 63-68, wherein the porous medium comprises metal screens or wires.

70. The apparatus of any one of claims 63-69, wherein the porous medium is 3D-printed.

71. The apparatus of any one of claims 1-70, wherein the fuel distributor distributes fuel radially outwardly.

72. The apparatus of any one of claims 1-71, wherein the fuel distributor distributes fuel radially inwardly.

73. The apparatus of any one of claims 1-72, wherein the fuel distributor is centered on the center longitudinal axis of the tube.

74. The apparatus of any one of claims 1-73, wherein the fuel distributor is tube-shaped.

75. The apparatus of any one of claims 1-74, wherein the fuel distributor comprise a plurality of orifices.

76. The apparatus of any one of claims 1-75, wherein the fuel distributor comprise a plurality of nozzles.

77. The apparatus of any one of claims 1-76, wherein the fuel distributor is positioned between the inner swirler and the outer swirler.

78. The apparatus of any one of claims 1-77, wherein the fuel distributor is contained within the tube.

79. The apparatus of any one of claims 1-78, wherein the fuel distributor is integrally formed with the tube.

80. The apparatus of any one of claims 1-79, wherein the fuel distributor is coplanar with the inner swirler.

81. The apparatus of any one of claims 1-80, wherein the fuel distributor is coplanar with the outer swirler.

82. The apparatus of any one of claims 1-81, further comprising a heater positioned to heat at least a portion of the fuel distributor.

83. The apparatus of claim 82, wherein the heater is positioned in the tube.

84. The apparatus of any one of claim 82 or 83, wherein the heater is centered on the center longitudinal axis of the tube.

85. The apparatus of any one of claims 82-84, wherein the heater is positioned in a center of the fuel distributor.

86. The apparatus of any one of claims 82-85, wherein the heater comprises an electric heater.

87. The apparatus of any one of claims 82-86, wherein the heater comprises a glow plug.

88. The apparatus of any one of claims 1-87, wherein the apparatus does not contain an ignition source.

89. The apparatus of any one of claims 1-88, further comprising a fuel supply in fluidic communication with the fuel distributor.

90. The apparatus of claim 89, wherein the fuel supply comprises a plurality of fuel channels connecting the fuel source to the fuel distributor.

91. The apparatus of any one of claim 89 or 90, wherein the fuel supply comprises a distribution channel positioned to distribute fuel to the fuel distributor.

92. The apparatus of claim 91, wherein the distribution channel is positioned to radially distribute fuel to the fuel distributor.

93. The apparatus of any one of claim 91 or 92, wherein the distribution channel is positioned at a circumference of the fuel distributor.

94. The apparatus of any one of claims 91-93, wherein the distribution channel is substantially circular.

95. The apparatus of any one of claims 89-94, wherein the fuel supply comprises a fuel source.

96. The apparatus of claim 95, wherein the fuel source comprises a diesel fuel source.

97. The apparatus of any one of claim 95 or 96, wherein the fuel source comprises a jet fuel source.

98. The apparatus of any one of claims 95-97, wherein the fuel source comprises a source of Jet A-1.

99. The apparatus of any one of claims 95-98, wherein the fuel source comprises a source of JP-4.

100. The apparatus of any one of claims 95-99, wherein the fuel source comprises a source of JP-8.

101. The apparatus of any one of claims 95-100, wherein the fuel source comprises a source of naphtha.

102. The apparatus of any one of claims 95-101, wherein the fuel source comprises a source of kerosene.

103. The apparatus of any one of claims 1-102, further comprising a pump configured to pump fuel to the fuel distributor.

104. The apparatus of claim 103, wherein the pump is configured to pump fuel at a flowrate of no more than 10 ml/min.

105. The apparatus of any one of claim 103 or 104, wherein the pump is configured to pump fuel at a flowrate of no more than 5 ml/min.

106. The apparatus of any one of claims 103-105, wherein the pump is configured to pump fuel from a fuel tank to the fuel distributor.

107. The apparatus of claim 106, wherein the fuel tank is pressurized.

108. The apparatus of any one of claims 1-107, further comprising a recuperator configured to direct gases exiting the tube at the outlet.

109. The apparatus of claim 108, wherein the recuperator is configured to direct gases in an upstream direction.

110. The apparatus of any one of claim 108 or 109, wherein the recuperator is configured to alter the direction of the flow of gases in a direction towards the inner swirler and the outer swirler.

111. The apparatus of any one of claims 108-110, wherein the recuperator is radially symmetric with respect to the center longitudinal axis of the tube.

112. The apparatus of any one of claims 108-111, wherein the recuperator is configured to pass heat from gases exiting the tube at the outlet to the first gas.

113. The apparatus of any one of claims 108-112, wherein the recuperator is configured to pass heat from gases exiting the tube at the outlet to the second gas.

114. The apparatus of any one of claims 108-113, wherein the recuperator comprises a heat exchanger.

115. The apparatus of claim 114, wherein the heat exchanger is a countercurrent heat exchanger.

116. The apparatus of claim 114, wherein the heat exchanger is a parallel flow heat exchanger.

117. The apparatus of any one of claims 1-116, wherein the thermal power generator comprises a photonic crystal.

118. The apparatus of claim 117, wherein the photonic crystal is external to the tube.

119. The apparatus of claim 117, wherein the photonic crystal is contained within the tube.

120. The apparatus of any one of claim 117 or 119, wherein the photonic crystal comprises 1-dimensional periodicity.

121. The apparatus of any one of claims 117-120, wherein the photonic crystal comprises 2-dimensional periodicity.

122. The apparatus of any one of claims 117-121, wherein the photonic crystal comprises a semiconductor.

123. The apparatus of any one of claims 117-122, wherein the photonic crystal comprises silicon.

124. The apparatus of any one of claims 117-123, wherein the photonic crystal selectively emits electromagnetic radiation.

125. The apparatus of claim 124, wherein the photonic crystal emits electromagnetic radiation within one or more predetermined ranges of wavelengths.

126. The apparatus of any one of claim 124 or 125, further comprising a thermophotovoltaic cell positioned to receive the electromagnetic radiation emitted from the photonic crystal.

127. The apparatus of any one of claims 117-126, wherein the thermal power generator comprises a thermoelectric generator.

128. The apparatus of any one of claims 117-127, wherein the thermal power generator comprises a thermionic generator.

129. An apparatus, comprising:
a tube having a volume of no more than 2000 cm³;
an inner swirler configured to direct a first gas to flow in a first tangential direction within the tube;
an outer configured to direct a second gas to flow in an opposed second tangential direction within the tube; and
a fuel distributor configured to distribute fuel between the first gas flow and the second gas flow.

130. An apparatus, comprising:
a cylindrical tube;
an inner swirler configured to direct a first gas to flow in a first tangential direction within the tube, centered on a longitudinal axis of the tube;
an outer swirler configured to direct a second gas to flow in an opposed second tangential direction within the tube, centered on a longitudinal axis of the tube;
a fuel distributor configured to distribute fuel between the first gas flow and the second gas flow; and
a heater positioned to heat at least a portion of the fuel distributor.

131. An apparatus, comprising:
a tube having an outlet;
an inner swirler configured to direct a first gas to flow in a first tangential direction within the tube and in a longitudinal direction towards the outlet;
an outer swirler configured to direct a second gas to flow in an opposed second tangential direction within the tube and in a longitudinal direction towards the outlet; and
a recuperator configured to direct gases exiting the tube at the outlet, in a direction towards the inner swirler and the outer swirler.

132. An apparatus, comprising:
a tube having an outlet;
an inner swirler configured to direct a first gas to flow in a first tangential direction within the tube and in a longitudinal direction towards the outlet;
an outer swirler configured to direct a second gas to flow in an opposed second tangential direction within the tube and in a longitudinal direction towards the outlet; and
a recuperator for passing heat from gases exiting the tube at the outlet to the first gas entering the inner swirler and/or the second gas entering the outer swirler.

133. A method, comprising:
swirling a first gas in a first tangential direction as the first gas flows longitudinally in a tube;
swirling a second gas in an opposed second tangential direction as the second gas flows longitudinally in a tube;
flowing a liquid fuel between the first gas and the second gas within the tube; and
igniting the fuel by heating the fuel to a temperature greater than the autoignition temperature of the fuel.

134. The method of claim 133, wherein the tube has an inner diameter less than 10 cm.

135. The method of any one of claim 133 or 134, wherein the tube has a volume of no more than 1000 cm³.

136. The method of any one of claims 133-135, wherein the tube has a length of no more than 50 cm.

137. The method of any one of claims 133-136, wherein the tube is substantially cylindrical.

138. The method of any one of claims 133-137, wherein the first gas comprises air.

139. The method of any one of claims 133-138, wherein the first gas enters the tube at a temperature of at least 200° C.

140. The method of any one of claims 133-139, wherein the first gas enters the tube at a temperature of at least 400° C.

141. The method of any one of claims 133-140, wherein the first gas enters the tube at a temperature of at least 600° C.

142. The method of any one of claims 133-141, wherein the first gas enters the tube at a pressure of at least 100 Pa (gauge).

143. The method of any one of claims 133-142, wherein the first gas enters the tube at a flow rate of no more than 200 m/s.

144. The method of any one of claims 133-143, wherein the first gas enters the tube at a flow rate of no more than 50 m/s.

145. The method of any one of claims 133-144, wherein the first gas enters the tube at a flow rate of no more than 5 m/s.

146. The method of any one of claims 133-145, comprising swirling the first gas at a Swirl Number of at least 0.5.

147. The method of any one of claims 133-146, comprising swirling the first gas in a clockwise direction as the first gas flows longitudinally in the tube.

148. The method of any one of claims 133-147, comprising swirling the first gas in a counterclockwise direction as the first gas flows longitudinally in the tube.

149. The method of any one of claims 133-148, wherein the second gas comprises air.

150. The method of any one of claims 133-149, wherein the second gas enters the tube at a temperature of at least 200° C.

151. The method of any one of claims 133-150, wherein the second gas enters the tube at a temperature of at least 600° C.

152. The method of any one of claims 133-151, wherein the second gas enters the tube at a pressure of at least 100 Pa (gauge).

153. The method of any one of claims 133-152, wherein the second gas enters the tube at a flow rate of no more than 200 m/s.

154. The method of any one of claims 133-153, wherein the second gas enters the tube at a flow rate of no more than 50 m/s.

155. The method of any one of claims 133-154, wherein the second gas enters the tube at a flow rate of no more than 5 m/s.

156. The method of any one of claims 133-155, comprising swirling the second gas at a Swirl Number of at least 0.5.

157. The method of any one of claims 133-156, comprising swirling the second gas in a clockwise direction as the second gas flows longitudinally in the tube.

158. The method of any one of claims 133-157, comprising swirling the second gas in a counterclockwise direction as the second gas flows longitudinally in the tube.

159. The method of any one of claims 133-158, wherein the first gas and the second gas are compositionally identical.

160. The method of any one of claims 133-159, wherein the first gas and the second gas arise from the same source.

161. The method of any one of claims 133-160, wherein flowing the fuel comprises vaporizing the fuel within the tube.

162. The method of claim 161, wherein vaporizing the fuel comprises heating the fuel to a temperature greater than a boiling point of the fuel.

163. The method of any one of claim 161 or 162, wherein vaporizing the fuel comprises heating the fuel using the first gas and/or the second gas.

164. The method of any one of claims 161-163, wherein vaporizing the fuel comprises heating the fuel to a temperature of at least 200° C.

165. The method of any one of claims 161-164, wherein vaporizing the fuel comprises heating the fuel to a temperature of at least 300° C.

166. The method of any one of claims 133-165, comprising flowing the fuel into the tube at a flow rate of less than 10 ml/min.

167. The method of any one of claims 133-166, comprising flowing the fuel into the tube at a flow rate of less than 5 ml/min.

168. The method of any one of claims 133-167, comprising flowing the fuel into the tube at a flow rate of at least 5 m/s.

169. The method of any one of claims 133-168, wherein flowing the fuel comprises forming droplets of fuel having an average droplet diameter of less than 25 micrometers.

170. The method of any one of claims 133-169, wherein the fuel has an autoignition temperature of at least 200° C.

171. The method of any one of claims 133-170, wherein the fuel has an autoignition temperature of at least 600° C.

172. The method of any one of claims 133-171, comprising heating the fuel using the first gas.

173. The method of any one of claims 133-172, comprising heating the fuel using the second gas.

174. The method of any one of claims 133-173, comprising heating the fuel using a heater.

175. The method of any one of claims 133-174, comprising heating the fuel using a reaction within the tube.

176. The method of any one of claims 133-175, further comprising oxidizing the fuel.

177. The method of claim 176, comprising completely oxidizing at least 50 mol % of the fuel.

178. The method of any one of claim 176 or 177, comprising completely oxidizing at least 90 mol % of the fuel.

179. The method of any one of claims 176-178, comprising flowing the first gas, the second gas, and the fuel in the tube at flow rates such that oxygen within the first gas and/or the second gas is present at no more than 50 mol % over the stochiometric amount of oxygen that completely oxidize the fuel.

180. The method of any one of claims 176-179, comprising flowing the first gas, the second gas, and the fuel in the tube at flow rates such that oxygen within the first gas and/or the second gas is present at no more than 25 mol % over the stochiometric amount of oxygen that completely oxidize the fuel.

181. The method of any one of claims 176-180, comprising flowing the first gas, the second gas, and the fuel at flow rates in the tube such that oxygen within the first gas and/or the second gas is present at no more than 20 mol % over the stoichiometric amount of oxygen that completely oxidize the fuel.

182. The method of any one of claims 176-181, comprising flowing the first gas, the second gas, and the fuel at flow rates in the tube such that oxygen within the first gas and/or the second gas is present at no more than 10 mol % over the stoichiometric amount of oxygen that completely oxidize the fuel.

183. The method of any one of claims 176-182, wherein oxidizing the fuel produces heat.

184. The method of claim 183, wherein the heat is used for heating the first gas and/or the second gas to produce a heated exhaust.

185. The method of any one of claim 183 or 184, comprising heating the first gas and/or the second gas to at least 800° C.

186. The method of any one of claims 183-185, comprising heating the first gas and/or the second gas to at least 1000° C.

187. The method of any one of claims 183-186, comprising heating the first gas and/or the second gas to at least 1100° C.

188. The method of any one of claims 183-187, further comprising using the heated exhaust to produce power.

189. The method of any one of claims 183-188, further comprising exposing a thermal power generator to the heated exhaust.

190. The method of claim 189, wherein the thermal power generator comprises a photonic crystal.

191. The method of any one of claim 189 or 190, wherein the thermal power generator comprises a thermoelectric generator.

192. The method of any one of claims 189-191, wherein the thermal power generator comprises a thermionic generator.

193. The method of any one of claims 133-192, wherein the fuel is turbulently mixed between the first gas and the second gas.

194. The method of any one of claims 133-193, wherein the fuel comprises diesel fuel.

195. The method of any one of claims 133-194, wherein the fuel comprises jet fuel.

196. The method of any one of claims 133-195, wherein the fuel comprises Jet A-1.

197. The method of any one of claims 133-196, wherein the fuel comprises JP-4.

198. The method of any one of claims 133-197, wherein the fuel comprises JP-8.

199. The method of any one of claims 133-198, wherein the fuel comprises naphtha.

200. The method of any one of claims 133-199, wherein the fuel comprises kerosene.

201. The method of any one of claims 133-200, flowing the fuel between the first gas and the second gas using a fuel distributor.

202. The method of claim 201, wherein the fuel distributor comprises a porous medium.

203. The method of any one of claims 201-202, wherein the fuel autoignites at least 1 cm away from the fuel distributor.

204. The method of any one of claims 201-203, wherein the fuel autoignites within 5 cm from the fuel distributor.

205. The method of any one of claims 133-204, further comprising initiating a reaction between the fuel and the first gas and/or the second gas by applying heat to the fuel.

206. The method of claim 205, wherein applying heat comprises applying radiative heat to the fuel to heat the fuel.

207. A method, comprising:
vaporizing a fuel to produce a vaporized fuel;
passing the vaporized fuel between a first gas and a second gas within a tube, the first gas flowing in a first direction and the second gas flowing in an opposed second direction;
heating the vaporized fuel to a temperature of at least 1000° C.;
oxidizing the fuel to produce a heated exhaust; and
exposing a thermal power generator to the heated exhaust.

208. The method of claim 207, comprising vaporizing the fuel using a piezoelectric vaporizer.

209. The method of any one of claim 207 or 208, comprising vaporizing the fuel within a fuel distributor.

210. The method of claim 209, wherein the fuel distributor comprises a porous medium.

211. A method, comprising:
atomizing a liquid fuel to produce a atomized fuel having an average diameter of less than 25 micrometers;
passing the atomized fuel between a first gas and a second gas within a tube, the first gas flowing in a first direction and the second gas flowing in an opposed second direction;
heating the atomized fuel to a temperature of at least 300° C.;
oxidizing the fuel to produce a heated exhaust; and
exposing a thermal power generator to the heated exhaust.

212. A method, comprising:
flowing fuel into a tube at a flow rate of less than 15 ml/min;
flowing air into the tube at a flow rate such that oxygen within the air is present at more than 10 mol % over the stochiometric amount of oxygen that completely oxidize the fuel;
completely oxidizing at least 90 mol % of the fuel within the tube to produce a heated exhaust; and
exposing a photonic crystal to electromagnetic radiation from the heated exhaust.

213. A method, comprising:
flowing fuel into a tube at a flow rate of less than 10 ml/min;
flowing air into the tube;
heating the fuel to a temperature of at least 1000° C.;
oxidizing the fuel using oxygen in the air to produce a heated exhaust; and
using the heated exhaust to heat the air before flowing the air into the tube.

214. A method, comprising:
passing a vaporized fuel between a first gas flowing in a first direction and a second gas flowing in a second, opposed direction; and
heating the fuel to a temperature greater than the autoignition temperature of the fuel.

215. An apparatus, comprising:
a tube having an inlet and an outlet;
a recuperator configured to direct gases exiting the tube at the outlet, in a direction towards the inlet; and
a photonic crystal external to the tube.

216. The apparatus of claim 215, wherein the gases exiting the tube are in thermal communication with the photonic crystal.

217. The apparatus of any one of claim 215 or 216, wherein the gases exiting the tube contact the photonic crystal.
